(19) United States
(12) Patent Application Publication
(10) Pub. No.: US 2021/0170892 A1
(43) Pub. Date: Jun. 10, 2021

(54) LOCKER FOR STORAGE AND ELECTRIC CHARGING OF PERSONAL MOBILITY DEVICES

(71) Applicant: QOOBERS SMART SOLUTIONS, S.L., Barcelona (ES)

(72) Inventor: Eduard ALBORS RIPOLL, Barcelona (ES)

(21) Appl. No.: 17/113,610

(22) Filed: Dec. 7, 2020

(30) Foreign Application Priority Data
Dec. 5, 2019 (ES) U201931990

(51) Int. Cl. B60L 53/30; H02J 7/00; B62H 5/00; B60L 58/10; B60L 53/18; B60L 53/16

(52) U.S. Cl. CPC B60L 53/30; H02J 7/0042; B60L 53/16; B60L 58/10; B60L 53/18; B62H 5/00

(57) ABSTRACT

A locker for storage and electric charging of personal mobility devices, which is mainly designed for electric scooters or kickscooters and folding electric bicycles. The locker is configured from a container structure, which can present variable configurations (one or more cubicles) with enough space to keep the vehicle. Each of the cubicles is equipped with an access door with a lock-opening system (preferably an intelligent electronic control lock operated by a mobile phone) and a charging system for the vehicle's battery.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The field of application of the present invention is framed within the sector of the industry dedicated to the manufacture of safety storage systems and battery charging.

The invention, as expressed in the wording of the current specification, refers to a locker for storage and electric charging of personal mobility devices that provides advantages and characteristics, which are described in detail later, and which involve an improvement of the current state of the art.

More in particular, the object of the invention focuses on a safe storage and electric charging system for small personal mobility devices (mainly designed for electric scooters or kickscooters and folding electric bicycles). It is configured from a container structure, which can present variable configurations (one or more cubicles) with enough space to keep the vehicle. Each of the cubicles is equipped with an access door with a lock-opening system (preferably an intelligent electronic control lock operated by means of a mobile phone) and a charging system for the vehicle's battery.

### 2. Description of Related Art Including Information Disclosed Under 37 CFR 1.97 and 37 CFR 1.98

As is known, the use of personal mobility devices, such as kickscooters and bicycles, that work with electric batteries is increasingly widespread. The use of these type of vehicles, despite their advantages in terms of economic savings and ease of movement, especially on short trips and urban environments, present two notable problems.

On the one hand, as they are very light vehicles, leaving them parked on public roads, even if tied with chain systems or similar, can pose a significant risk of theft, especially if they are left at night or for long periods of time. They can also pose a municipal problem if the public road is unduly occupied or if they are tied to street furniture. On the other hand, taking them inside buildings or premises, whether at work, in shops or in places of leisure, also pose a problem, since they take up space and can disturb, and can also be susceptible to be stolen.

Another problem is the following: when dealing with electric vehicles, and the battery runs out, they need to connect to an electrical outlet to recharge said battery or otherwise the vehicle does not work. If it is a privately owned vehicle, this often means that the battery must be plugged in at some inappropriate point, which also forces the user to remain next to the vehicle while its battery is being charged. And, in the case of sharing vehicles, the company that manages them is obliged to collect the vehicles with the exhausted battery and take them to a location where they can be recharged or to replace the discharged battery with a charged one, which in any case supposes an important economic expense for the company.

The objective of the present invention is, therefore, to provide the market with a safe storage system, in order to be able to leave these type of vehicles in places specifically appropriate for them. With this system, they will not disturb and that they cannot be unduly stolen, and at the same time, it provides a safe recharging point for the battery so that, while the vehicle is left in storage, the battery is being charged to be ready at the time the vehicle is collected again. This system is also ideal for its implementation as a public payment service and suitable for installation both on public roads and in facilities of all kinds, whether public or private.

On the other hand, and as a reference to the current state of the art, it should be noted that, at least by the applicant, the existence of any other locker for storage and electric charging of personal mobility devices is unknown, nor any other invention of similar application, which presents technical, structural and constitutive characteristics equal or similar to those presented herein.

### BRIEF SUMMARY OF THE INVENTION

The locker for storage and electric charging of personal mobility devices that the invention proposes enables the aforementioned objectives to be satisfactorily achieved. The characterizing details that make it possible and that distinguish it conveniently are included in the final claims that accompany this description.

Specifically, the locker proposed by the invention, as noted above, is configured as a safe storage and electric charging system for small personal mobility devices, mainly electric scooters or kick scooters and folding electric bicycles. The locker is made up of a container structure, which can have variable configurations defining one, two or more cubicles with space to keep the vehicle inside. Each of the cubicles is equipped with an access door with an opening system by means of a security lock and incorporates inside a charging system to connect the battery of the vehicle kept inside.

Preferably, the container structure that defines the cubicles is made up of multiple pieces of different shapes and sizes that, when combined, make it possible to define the lateral, upper and lower walls of the cubicles in different configurations. The material used for the manufacture of said pieces is, preferably, recycled PVC or Polyurethane.

For their part, the front and rear ends of the set of cubicles formed by the aforementioned pieces are left open and closed, respectively, by means of the doors with a security lock and some ventilation grills made of lacquered metal plates.

The door of each cubicle can be made of wood, lacquered metal sheet, tempered laminated glass or Plexiglas (Polymethylmethacrylate or PMMA). In any case, the security lock opening system, preferably, consists of an intelligent lock controlled wirelessly by a mobile phone application via Bluetooth, NFC (Near Field Communication), QR code, conventional mechanical locks or combination locks.

Finally, the charging system for the battery of the personal mobility electric device, preferably, consists of a charger that has a battery detection step that reads the values of the main electrical variables of the battery packs of the connected vehicle. As a consequence, it adapts the supplied power, making an efficient battery charge.

In addition, also preferably, the charger output has a cable with a multi-connector that contains the main models of power jacks used by these type of vehicles.

### BRIEF DESCRIPTION OF THE SEVERAL VIEWS OF THE DRAWINGS

To complement the description that is being made and in order to help a better understanding of the characteristics of the invention, the present descriptive report is accompanied, as an integral part thereof, by a set of drawings in which, for illustrative purposes and not limiting, the following has been represented.

FIG. 1 shows a schematic perspective view of an example of the locker for storage and electric charging of personal mobility devices object of the invention. Specifically, it shows an example with a container structure of multiple cubicles, its general configuration being appreciated and main parts.

FIG. 2 shows a schematic perspective view of the example of the locker according to the invention shown in FIG. 1, in this case represented with the exploded view of the cubicle container structure, showing the parts and elements that are missing of the electrical charging system.

### DETAILED DESCRIPTION OF THE INVENTION

In view of the aforementioned figures, and in accordance with the numbering adopted, one can see in them a non-limiting embodiment example of the proposed locker for storage and electric charging of personal mobility devices, which comprises what is described in detail below.

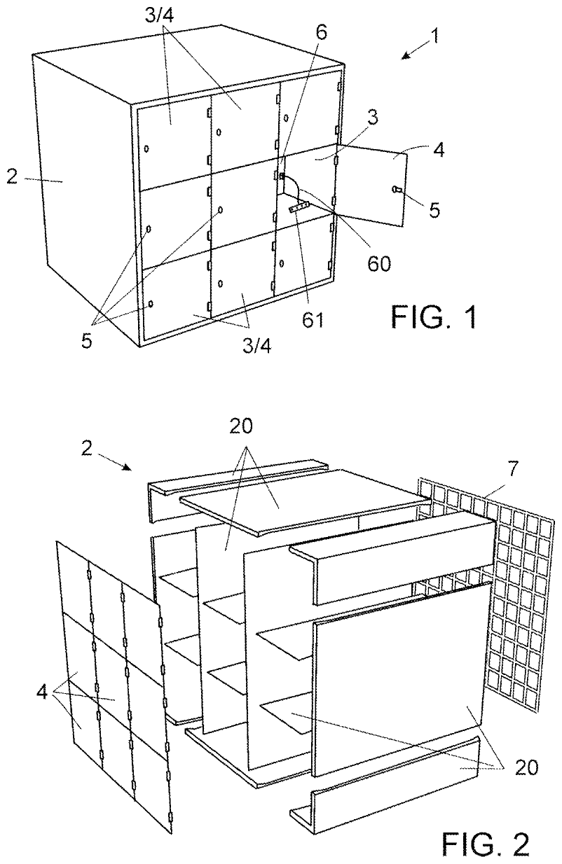

Thus, as seen in FIG. 1, the locker (1) is configured, essentially, from a container structure (2) of variable configuration that defines one, two or more cubicles (3) with space to keep the vehicle inside. Each of said cubicles (3) is equipped with an access door (4) with an opening system by means of a security lock (5) and equipped in its interior with an electric charging system (6) to connect the battery of the vehicle kept inside.

It should be noted that, although FIG. 1 shows an example in which the locker (1) has a container structure (2) that defines multiple cubicles (3) to keep various vehicles, it should be understood that said structure can have different shapes and sizes and define a greater or lesser number of cubicles (3).

Thus, in a preferred embodiment, said container structure (2) that defines the cubicles (3), as seen in FIG. 2, is made up of multiple pieces (20) of different shapes and sizes that are coupled to each other to define the lateral, upper and lower walls of the cubicles (3) in different configurations. The material used for the manufacture of said pieces (20) is, preferably, recycled PVC or Polyurethane. Furthermore, in said embodiment, the front and rear ends of the set of cubicles (3) that form the coupling of the aforementioned pieces remain open and get closed, respectively, by means of the doors (4) with the security lock (5). Such front and rear ends can be made of wood, lacquered metal sheet, tempered laminated glass or Plexiglas, and by means of one or more ventilation grills (7) made with lacquered metal sheet.

In any case, the security lock (5) of the doors (4) of the cubicles (3), preferably, is an intelligent lock controlled wirelessly by means of a mobile phone application via Bluetooth, NFC, QR code, conventional mechanical lock or by combination lock.

Finally, the electrical charging system (6) that each cubicle (3) has in order to recharge the battery of the vehicle kept in it. This charging system is, preferably, a charger with a battery detection step that reads the values of the main electrical battery variables of the device or battery packs and that adapts the energy supplied, making an efficient battery charge.

Furthermore, also preferably, the outlet of said charger (6) has a cable (60) equipped with a multi-connector (61), containing the main models of power jacks used by these type of vehicles. Having sufficiently described the nature of the present invention, as well as the way of putting it into practice, it is not considered necessary to make its explanation more extensive so that any expert in the field understands its scope and the advantages derived from it. Within its essentiality, it may be put into practice in other forms of implementation that differ in detail from the one indicated by way of example, and to which it will also achieve the protection that is sought provided that the fundamental principle is not altered, changed or modified.

I claim:

1. A locker for storage and electric charging of personal mobility devices that applies as a safe storage and electric charging system for small personal mobility vehicles such as electric scooters or kick scooters and folding electric bicycles, the locker characterized by being configured from a container structure with a variable configuration that defines one, two or more cubicles with space to keep the vehicle for which it is intended inside; each of said cubicles is equipped with an access door with an opening system by means of a security lock and equipped inside with an electrical charging system to connect the battery of the vehicle kept inside.

2. A locker for storage and electric charging of personal mobility devices, according to claim 1, characterized by a container structure that defines the cubicles and is formed by multiple pieces coupled to each other and that define the lateral, upper and lower walls of the cubicles; the front and rear ends of the set of cubicles that form the coupling of said pieces remain open and get closed, respectively, by the doors with the security lock and by means of one or more ventilation grills.

3. A locker for storage and electric charging of personal mobility devices, according to claim 1, characterized by the fact that the security lock of the doors of the cubicles is an intelligent lock controlled by wireless mode using a mobile phone application via Bluetooth, NFC, QR code or similar.

4. A locker for storage and electric charging of personal mobility devices, according to claim 1, characterized by the fact that the security lock of the doors of the cubicles is a conventional mechanical lock or combination lock.

5. A locker for storage and electric charging of personal mobility devices, according to claim 1, characterized by the fact that the electric charging system contained in each cubicle to charge the battery of the vehicle kept in it is a charger with battery detection and value reading of electric variables of the connected battery or battery packs.

6. A locker for storage and electric charging of personal mobility devices, according to claim 5, characterized by a charger outlet that has a cable equipped with a multi-connector.
